(19) United States
(12) Patent Application Publication
(10) Pub. No.: US 2025/0265310 A1
(43) Pub. Date: Aug. 21, 2025

(54) SYSTEMS AND METHODS FOR PARAMETER SEARCH AND ADJUSTMENT

(71) Applicant: DK Crown Holdings Inc., Boston, MA (US)

(72) Inventor: Robert Edward Barnes, Hertfordshire (GB)

(73) Assignee: DK Crown Holdings Inc., Boston, MA (US)

(21) Appl. No.: 18/583,087

(22) Filed: Feb. 21, 2024

(51) Int. Cl. G06F 17/18

(52) U.S. Cl. CPC G06F 17/18

(57) ABSTRACT

Systems and methods for parameter search and adjustment are disclosed. A system can maintain a model configured to generate odds data for one or more live events. The system can receive a request to generate odds values for a first live event. The request can include a set of target values for the first live event. The system can determine that the model is to be updated based on the request. The system can generate, using a set of first parameters for the first live event and prior to updating the model, first odds for the first live event in response to the request. The system can update the model based on the set of target values in the request.

### BACKGROUND

Models are crucial for understanding and explaining complex systems. By capturing the relationships between inputs and outputs, models can provide insights into how a system behaves and can provide predictions on the future outcomes of the system.

### SUMMARY

The systems and methods of this technical solution provide techniques for dynamically updating parameters for models that generate odds for live events. The parameters generated according to the techniques described herein can be used to enhance the accuracy and relevance of predictions or odds for live events. By dynamically updating the parameters, the system can adapt to real-time changes and new information, ensuring that the model's output reflects the most current and pertinent data. Conventional approaches can rely on static statistical models and periodic parameter updating. The systems and methods described herein provide techniques for automatically adjusting model parameters in response to live data feeds, user input, and changing conditions of live events. This dynamic adaptation leads to more responsive and precise modeling, significantly improving the reliability and utility of predictions over static models. Furthermore, this technology enables real-time recalibration of the model, a capability not typically found in traditional systems. The systems and methods described herein therefore provide a technical improvement over conventional systems for updating models.

At least one other aspect of the present disclosure is directed to a system. The system can maintain a model configured to generate odds data for one or more live events. The system can receive a request to generate odds values for a first live event. The request can include a set of target values for the first live event. The system can determine that the model is to be updated based on the request. The system can generate, using a set of first parameters for the first live event and prior to updating the model, first odds for the first live event in response to the request. The system can update the model based on the set of target values in the request.

In some implementations, the model can include a Monte-Carlo model. In some implementations, the request can include an indication that the model is to be updated. In some implementations, the system can generate a set of second parameters for the model that corresponding to the first live event. In some implementations, the system can store the set of second parameters in a database in association with an identifier of the first live event. In some implementations, the system can receive a second request to generate odds for the first live event. In some implementations, the system can retrieve the set of second parameters from the database. In some implementations, the system can execute the model using the set of second parameters to generate second odds for the first live event.

In some implementations, the system can update the model by iteratively generating candidate second parameters based on the set of target values. In some implementations, the system can store a plurality of sets of first parameters for the model in a database. The plurality of sets of first parameters can include the set of first parameters for the first live event. In some implementations, the system can generate the first odds for further based on an aggregation of the plurality of sets of first parameters. In some implementations, the system can generate the first odds for the first live event and initiate updating the model in parallel. In some implementations, the system can provide an indication to a second computing system that the model has been updated based on the set of target values.

At least one aspect of the present disclosure relates to a method. The method can be performed, for example, by one or more processors coupled to a non-transitory memory. The method can include maintaining a model configured to generate odds data for one or more live events. The method can include receiving a request to generate odds values for a first live event. The request can include a set of target values for the first live event. The method can include determining that the model is to be updated based on the request. The method can include generating, using a set of first parameters for the first live event and prior to updating the model, first odds for the first live event in response to the request. The method can include updating the model based on the set of target values in the request.

In some implementations, the method can include a Monte-Carlo model. In some implementations, the request can include an indication that the model is to be updated. In some implementations, the method can include generating a set of second parameters for the model that corresponding to the first live event. In some implementations, the method can include storing the set of second parameters in a database in association with an identifier of the first live event. In some implementations, the method can include receiving a second request to generate odds for the first live event. In some implementations, the method can include retrieving the set of second parameters from the database. In some implementations, the method can include executing the model using the set of second parameters to generate second odds for the first live event.

In some implementations, the method can include updating the model by iteratively generating candidate second parameters based on the set of target values. In some implementations, the method can include storing a plurality of sets of first parameters for the model in a database. The plurality of sets of first parameters can include the set of first parameters for the first live event. In some implementations, the method can include generating the first odds for further based on an aggregation of the plurality of sets of first parameters. In some implementations, the method can include generating the first odds for the first live event and initiate updating the model in parallel. In some implementations, the method can include providing an indication to a second computing system that the model has been updated based on the set of target values.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram of an example system for parameter search and adjustment, in accordance with one or more implementations;

FIG. 2 illustrates an example flow diagram of a method for parameter search and adjustment, in accordance with one or more implementations; and

FIG. 3 illustrates a block diagram of a server system and a client computer system in accordance with an illustrative implementation.

### DETAILED DESCRIPTION

Below are detailed descriptions of various concepts related to, and implementations of, techniques, approaches, methods, apparatuses, and systems for parameter search and adjustment. The various concepts introduced above and discussed in greater detail below may be implemented in numerous ways, as the described concepts are not limited to any particular manner of implementation. Examples of specific implementations and applications are provided primarily for illustrative purposes.

The systems and methods of this technical solution provide techniques for dynamically updating parameters for models that generate odds or other predictions for live events. The system can maintain a model configured to generate odds or other prediction data for one or more live events. The system can receive a request to generate predictions for a first live event. The request can include a set of target values for the first live event, with which parameters of the model are to be optimized. The system can determine that the model (e.g., parameters of the model, etc.) is to be updated based on the request. The system can generate, using a set of first parameters for the first live event and prior to updating the model, first odds for the first live event in response to the request. The system can update the model based on the set of target values in the request.

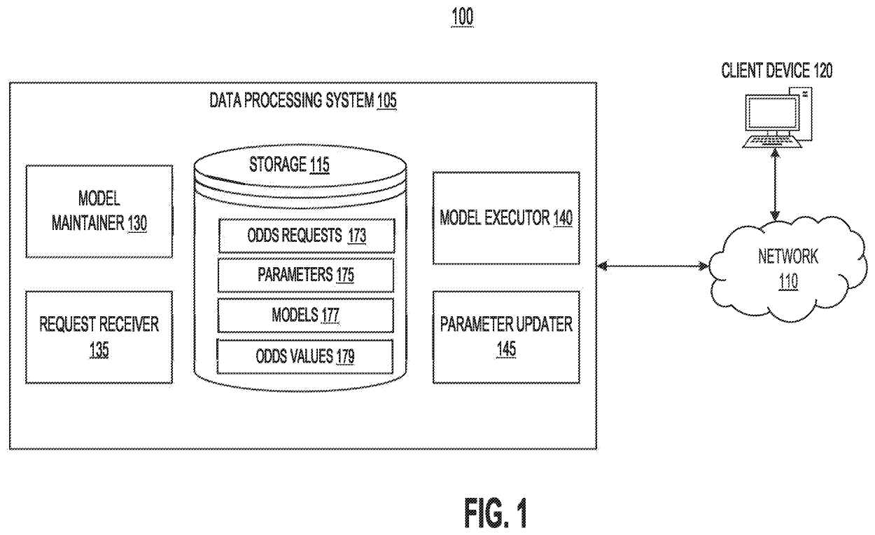

Referring now to FIG. 1, illustrated is a block diagram of an example system 100 for dynamically updating user interfaces, in accordance with one or more implementations. The system 100 can include at least one data processing system 105, at least one network 110, and at least one client device 120. The data processing system 105 can include a model maintainer 130, a request receiver 135, a model executor 140, a parameter updater 145, and at least one storage 115. The storage 115 can include one or more odds requests 173, parameters 175, one or more models 177, and odds values 179. Although shown here as internal to the data processing system 105, the storage 115 can be external to the data processing system 105, for example, as a part of a cloud computing system or an external computing device in communication with the devices (e.g., the data processing system 105, the client device 120, etc.) of the system 100 via the network 110.

Each of the components (e.g., the model maintainer 130, the request receiver 135, the model executor 140, the parameter updater 145, and the storage 115, etc.) of the system 100 can be implemented using the hardware components or a combination of software with the hardware components of a computing system, such as any other computing system described herein. Each of the components of the data processing system 105 can perform the functionalities detailed herein.

The data processing system 105 can include at least one processor and a memory (e.g., a processing circuit). The memory can store processor-executable instructions that, when executed by a processor, cause the processor to perform one or more of the operations described herein. The processor may include a microprocessor, an application-specific integrated circuit (ASIC), a field-programmable gate array (FPGA), a graphics processing unit (GPU), a tensor processing unit (TPU), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The data processing system 105 can include one or more computing devices or servers that can perform various functions as described herein.

In some implementations, the data processing system 105 may communicate with the client device 120, for example, to receive odds for sporting events, via the network 110. In one example, the data processing system 105 can be or can include an application server or webserver, which may include software modules allowing various computing devices (e.g., the client device 120, etc.) to access or manipulate data stored by the data processing system 105.

The network 110 can include computer networks such as the Internet, local, wide, metro or other area networks, intranets, satellite networks, other computer networks such as voice or data mobile phone communication networks, or combinations thereof. The data processing system 105 of the system 100 can communicate via the network 110 with one or more computing devices, such as the one or more client device 120. The network 110 may be any form of computer network that can relay information between the data processing system 105, the one or more client device 120, and one or more information sources, such as web servers or external databases, amongst others. In some implementations, the network 110 may include the Internet and/or other types of data networks, such as a local area network (LAN), a wide area network (WAN), a cellular network, a satellite network, or other types of data networks. The network 110 may also include any number of computing devices (e.g., computers, servers, routers, network switches, etc.) that are configured to receive or transmit data within the network 110.

The network 110 may further include any number of hardwired or wireless connections. Any or all of the computing devices described herein (e.g., the data processing system 105, the one or more client device 120, the server system 300, etc.) may communicate wirelessly (e.g., via Wi-Fi, cellular communication, radio, etc.) with a transceiver that is hardwired (e.g., via a fiber optic cable, a CAT5 cable, etc.) to other computing devices in the network 110. Any or all of the computing devices described herein (e.g., the data processing system 105, the one or more client device 120, the computer system 100, etc.) may also communicate wirelessly with the computing devices of the network 110 via a proxy device (e.g., a router, network switch, or gateway).

The client device 120 can include at least one processor and a memory (e.g., a processing circuit). The memory can store processor-executable instructions that, when executed by the processor, cause the processor to perform one or more of the operations described herein. The processor can include a microprocessor, an ASIC, an FPGA, a GPU, a TPU, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language. The client device 120 can include at least one computing device or server that can perform various operations as described herein.

The client device 120 can be a smartphone device, a mobile device, a personal computer, a laptop computer, a television device, a broadcast receiver device (e.g., a set-top box, a cable box, a satellite receiver box, etc.), or another type of computing device. The client device 120 can be implemented hardware or a combination of software and hardware. The client device 120 can include a display or display portion. The display can include a touchscreen display, a display portion of a television, a display portion of a computing device, a monitor, a GUI, or another type of interactive display (e.g., a touchscreen, a graphical interface, etc.) and one or more I/O devices (e.g., a touchscreen, a mouse, a keyboard, digital key pad). The client device 120 can include or be identified by a device identifier, which can be specific to each respective client device 120. The device identifier can include a script, code, label, or marker that identifies a particular client device 120. In some implementations, the device identifier can include a string or plurality of numbers, letters, characters, or any combination numbers, letters, and characters. In some embodiments, each client device 120 can have a unique device identifier.

In some implementations, in response to interactions with corresponding user interface elements, the application executing on a client device 120 can transmit information via a graphical user interface provider 130, such as odds for sporting events, parameters 175, and game statistics (e.g., goals scored, possession percentage, number of shots on goal, pass accuracy, number of corners, fouls committed, offsides, saves by the goalkeeper). The graphical user interface provider 130 can provide the odds for sporting events by running requests on a client device, using a range of game-related inputs. The odds can be queries for predicting outcomes of sporting events. The requests can be hypertext transfer protocol (HTTP or HTTPS) request messages, file transfer protocol messages, email messages, text messages, or any other type of message that can be transmitted via the network 110.

In some implementations, the client device 120 can participate in the process of generating odds or predictions for live events by initiating and coordinating requests. The client device 120 can send requests (e.g., odds requests 173) to the data processing system 105 for odds or predictions on live events, in some implementations. The requests can include criteria or conditions that the user wants to be factored into the odds generation process. For example, a client device 120 can request odds for a football match while specifying various input data to generate the odds, such as game state information, weather conditions, or historical performance data.

In some implementations, one or more client devices 120 can establish one or more communication sessions with the data processing system 105. A communication session can include a channel or connection between the data processing system 105 and a respective client device 120. The one or more communication sessions can each include an application session (e.g., virtual application), an execution session, a desktop session, a hosted desktop session, a terminal services session, a browser session, a remote desktop session, a URL session or a remote application session. Each communication session can include encrypted or secure sessions, which can include an encrypted file, encrypted data, or traffic.

In some implementations, the storage 115 can be a computer-readable memory that can store or maintain any of the information described herein. The storage 115 can store or maintain one or more data structures, which may contain, index, or otherwise store each of the values, pluralities, sets, variables, vectors, numbers, or thresholds described herein. The storage 115 can be accessed using one or more memory addresses, index values, or identifiers of any item, structure, or region maintained in the storage 115. The storage 115 can be accessed by the components of the data processing system 105, or any other computing device described herein, via the network 110. In some implementations, the storage 115 can be internal to the data processing system 105. In some implementations, the storage 115 can exist external to the data processing system 105 and may be accessed via the network 110. The storage 115 can be distributed across many different computer systems or storage elements and may be accessed via the network 110 or a suitable computer bus interface. The data processing system 105 can store, in one or more regions of the memory of the data processing system 105, or in the storage 115, the results of any or all computations, determinations, selections, identifications, generations, constructions, or calculations in one or more data structures indexed or identified with appropriate values.

Any or all values stored in the storage 115 may be accessed by any computing device described herein, such as the data processing system 105, to perform any of the functionalities or functions described herein. In some implementations, a computing device, such as a client device 120, may utilize authentication information (e.g., username, password, email, etc.) to show that the client device 120 is authorized to access requested information in the storage 115. The storage 115 may include permission settings that indicate which players, devices, or profiles are authorized to access certain information stored in the storage 115. In some implementations, instead of being internal to the data processing system 105, the storage 115 can form a part of a cloud computing system. In such implementations, the storage 115 can be a distributed storage medium in a cloud computing system and can be accessed by any of the components of the data processing system 105, by the one or more client device 120 (e.g., via one or more graphical user interfaces 130, etc.), or any other computing devices described herein.

The storage 115 can include odds requests 173, parameters 175, models 177, and odds values 179. The storage 115 can store or maintain one or more sets of input parameters 175 for the model 177. The parameters 175 can include team statistics and data on team performance, individual player statistics, betting data (e.g., betting trends, volumes of bets placed on different outcomes, historical accuracy of odds provided for similar events), and proxies or values for market conditions. The parameters 175 can include weight factors that can provide weight to variables in the model 177, such as home advantage, player form, or team rankings. The parameters 175 can include threshold values and points at which the model 177 output changes significantly (e.g., the point spread at which betting odds shift). The parameters 175 can include regularization coefficients to prevent overfitting. The parameters 175 can include statistical model coefficients and probability distribution parameters. The parameters 175 can include learning rates that can determines how quickly a model 177 adjusts its parameters in response to new data. The parameters 175 can include time decay factors that can adjust the weight factors of certain data as a live event or game progresses (e.g., a rate of decay). The parameters 175 can use feature selection indicators and feature masking techniques. The parameters 175 can mask features that do not contribute to the model's predictive power. For example, the parameters 175 can include Boolean flags or selectors indicating which features are active (unmasked) and which are inactive (masked). The parameters 175 can include dimensionality reduction factors to reduce the dimensionality of the data. The parameters 175 can include a value (random seed) used to initialize the random number generator. The parameters 175 can specify the number of simulations to be run. The parameters 175 can define distribution parameters such as means, variances, or other characteristics for a chosen distribution. The parameters 175 can include correlation matrices to account for the relationship between multiple stochastic variables.

The storage can store or maintain one or more odds requests 173 (also sometimes referred to as request(s) 173). The requests 173 can include information and criteria relevant to the event for which odds are being calculated. For example, in a sports betting scenario, an odds request 173 can specify the teams involved, relevant player statistics, historical performance data, current rankings, and any recent changes like player injuries or managerial shifts, or any other data that may be used as input to one or more models 177 for generating odds or predictions relating to a live event. The system can store additional request attributes or metadata such as the time of the request, the priority level, and any specific conditions or information indicated by the user. The request attributes can allow the model 177 to process each request 173 accurately and ensure that the generated odds are as relevant and timely as possible. The ability to store and retrieve the requests 173 can allow for a robust and responsive modeling system that can efficiently handle a wide array of scenarios and continuously update its outputs based on the latest available information.

The request receiver 135 can accept requests from the client device 120 or other systems or devices. The request receiver 135 can accept requests of various formats and protocols (e.g., HTTP, WebSocket, etc.). The request receiver 135 can receive a request to generate odds values for a first live event. The request can include a set of target values for the first live event. The live event can include baseball games, hockey games, basketball games, or other types of sports events. The request receiver 135 can store the odds request 173 in the storage. The target values can include statistical benchmarks that can include historical and current season statistics that might influence the odds, such as team performance metrics or player stats. The target values can include benchmarks or goals that the odds generation model 177 is expected to consider during its computation process.

The request or target values can include a flag or indicator. The flag can signal whether the model parameters 175 require updating based on the new request. For example, a model update flag could be set to true, indicating that the incoming data or the nature of the request necessitates a recalibration or adjustment of the model's parameters. In another example, if the flag is set to false, the data processing system 105 can receive an indication from the request receiver 135 that the current parameters are adequate for generating odds for the particular event, and no update is necessary. The flag mechanism can ensures that the model maintains flexibility and responsiveness to varying requirements of each request, and can optimize accuracy and computational efficiency.

The target values can be used to adjust the parameters 175 of a model 177 for one or more specified live events to reflect expected probabilities or outcomes. The target values can allow the odds to be competitive and in line with market trends or the bookmaker's strategic position. The target values can be benchmarks factored into the odds calculation. The target values can include outcome probabilities such as the likelihood of different outcomes, such as win, loss, or draw or game totals (Over/Under). The target values can include point spreads (expected difference in score between two competing teams) and market positions (data about how the odds can be positioned relative to the market to attract bets or to stay competitive). The target values can be provided by the users (e.g., experts). The target values can be based on historical data, expert analysis, or random selection. The target values generated via input to the data processing system, via input to the client device 120, or may be generated by an external computing system.

The request receiver 135 can determine that the model is to be updated based on the odds request 173. The odds request 173 can include an event identifier (e.g., information that identifies the live event such as game number). The odds request 173 can include target values and benchmarks that the odds calculation can take into account. The odds request 173 can include a query about information needed to compute the odds of an event. The request receiver 135 can determine that the model is to be updated based on the request. The request can include a set of target values for the first live event. The odds request 173 can include an indication that the model 177 is to be updated. The request receiver 135 can analyze the odds request 173 for certain triggers or flags that indicate the model update is necessary. The triggers or flags can be explicit instructions from the client device 120 or inferred from the data provided. The odds request 173 can include a Boolean flag.

The storage 115 can store or maintain one or more models 177. The models 177 can include the algorithms, parameters, and configurations for the predictive analytics. The models 177 can include, but are not limited to, Monte Carlo models, regression models, decision trees, neural networks, deep learning networks, time series models, reinforcement learning models, or ensemble methods. The models 177 can include layered structures. Each layer can perform different transformations on data in the models 177. The models 177 can include linear regression, logistic regression, support vector machines, and random forests. The models 177 can include labeled training data for classification or regression tasks. In some implementations, one or more of the models 177 can implement unsupervised techniques such as k-means clustering, hierarchical clustering, and principal component analysis. The models 177 can have outputs that can be a single value (like a prediction), a class label (in classification tasks), a probability score, or complex data structure (like the coordinates of objects in an image). The models 177 output can include odds values 179. After the models 177 are executed, the models 177 output can be stored in the storage 115. The models 177 output can include the predictions, odds values 179, scores, evaluations, and any other output generated by the models. The models 177 output can be used in analysis, reporting, and to inform further model training and refinement.

Referring now the operations of the data processing system 105, the model maintainer 130 can maintain one or more models 177 configured to generate odds data for one or more live events. The model maintainer 130 can maintain a model configured to generate odds data for one or more live events. The model maintainer 130 can select the type of model 177 (e.g., Monte-Carlo, another type of model, etc.) and the input data for generating the odds data. A Monte-Carlo-based model can be selected for its ability to model complex systems and processes by using randomness and statistical distribution to predict outcomes. The model maintainer 130 can select the type of model 177 based on the nature of the live events, which can include sports events. The model maintainer 130 can train the model 177 using historical data. The model maintainer 130 can scale the model 177 to handle large numbers of simultaneous requests. The model maintainer 130 can retrain, update, execute, or otherwise provide the model 177. The model maintainer 130 can monitor the performance of the model 177 (e.g., computational performance, model efficiency, etc.). The model maintainer 130 can select a set of initial parameters 175. The initial parameters 175 can be based on historical data, expert analysis, or random selection.

The model maintainer 130 can maintain, fine-tune, and adjust the parameters 175 of the model 177. For each live event or scenario, the model maintainer 130 can select and adjust the parameters 175 to reflect the current conditions and potential outcomes. The model maintainer 130 can define, manage, modify, update, or adjust the parameters 175. The model maintainer 130 can adjust threshold values that can determine changes in the model 177 output, such as the shift in betting odds based on evolving game dynamics. The model maintainer 130 can modify, update, adjust, or fine-tune the regularization coefficients to prevent overfitting, and to ensure that the model remains robust and generalizable to different scenarios. The model maintainer 130 can manage, modify, update, or adjust the statistical model coefficients and probability distribution parameters, which can be fundamental to the stochastic nature of Monte Carlo modeling. The model maintainer 130 can manage, modify, update, or adjust the learning rates that can set dictate the speed at which the model 177 adapts to new data. The model maintainer 130 can implements time decay factors to adjust the significance of data over the course of a live event (e.g., diminishing or increasing relevance of certain information as the event progresses).

The model maintainer 130 can employ advanced techniques like feature selection indicators and masking to enhance the model's predictive power. By identifying and activating relevant features (unmasking) and suppressing irrelevant or redundant ones (masking), the model maintainer 130 can focus on the most impactful data, improving both efficiency and accuracy. The model maintainer 130 can reduce the complexity of the data set to simplify the model without losing critical information (dimensionality reduction). The model maintainer 130 can initialize the random number generator with a random seed to ensure reproducibility in the modeling. The model maintainer 130 can specify the number of simulations and define, manage, modify, update, or adjust distribution parameters such as means and variances. The model maintainer 130 can define, manage, modify, update, or adjust correlation matrices to account for interdependencies among variables.

The model executor 140 can generate first odds/predictions for the first live event in response to the request. To do so, the model executor 140 can execute the model 177 selected for the request using a set of first parameters 175 for the first live event. Predictions generated using the model 177 can be generated prior to, or concurrently with, updating the parameters 175 of the model 177, in some implementations. The model executor 140 can execute the model 177 within an execution environment. The model executor 140 can operationalize the model 177 by using a set of inputs to generate candidate data points for the live events. In some implementations, the model executor 140 and parameter optimization within the data processing system 105 may be implemented in whole or in part in a specialized, isolated computing environment, such as a container, virtual machine, or a dedicated software environment. This can ensure that the optimization process can be executed in a controlled and secure setting, and can minimize interference with other system operations and enhance overall computational efficiency and reliability. The inputs can include various real-time data points such as game scores, player performance statistics, environmental conditions, and other relevant information about the live event. The inputs can the odds request 173 and parameters 175. The parameters 175 can be for the first live event and prior to updating the model. The model executor 140 can run the model 177.

The model executor 140 can use the inputs to generate first odds for the first live event in response to the request. The first odds can be model outputs (odds values 179). The odds values 179 can be stored in the storage 115. The model executor 140 can run a series of Monte Carlo simulations using the initial parameters 175 to generate a large number of random samples for the model output. Each simulation iteration can produce an outcome based on the current parameters. After each simulation, the results can be compared with the target output. The comparison can be quantified using a metric such as mean squared error (MSE), which measures the average of the squares of the errors (average squared difference between the estimated values and the actual value).

The parameter updater 145 can update the model 177 based on the set of target parameters/values in the odds request 173. To do so, the parameter updater 145 can iteratively generate candidate input parameters 175 based on the set of target values. The parameter updater 145 can adjust the parameters 175 that the model 177 uses to generate odds for the live events. The parameter updater 145 can update the model 177 based on the set of target values in the request. The parameter updater 145 can compare the received target values against the outputs of the model (odds values 179). The parameter updater 145 can use the target values to adjust the model parameters 175 until the model's generated odds (odd values 179) align with the target odds included in the request. The parameters 175 can be adjusted based on the results of the comparison. The parameters 175 can be adjusted based on a gradient descent where the parameters can be adjusted in the direction that reduces the mean squared error. The parameters 175 can be adjusted using genetic algorithms. The parameters 175 can be adjusted using a probabilistic model to guide the search for optimal parameters (e.g., Bayesian optimization). The model executor 140 can repeat the Monte Carlo simulations with the adjusted parameters, optimizing to achieve outputs that conform to the target values specified in the odds requests 173. The model executor 140 can continue an iterative process of simulation, comparison, and parameter adjustment until the model's output closely aligns with the target output. The iterative process can involve analyzing the model 177 current output (e.g., odd values 179 generated using the current iteration of the parameters 175 for the model 177 and live event), comparing it to the target values, and then adjusting the parameters to reduce the difference between the two. The model executor 140 can determine a convergence criterion for the iterative process, such as a threshold for mean squared error or a maximum number of iterations. Once the convergence criteria are met, the model executor 140 can consider that the optimal parameters 175 are found.

In some implementations, the parameter updater 145, via the model executor 140, can generate a set of second parameters for the model that corresponding to the first live event. The set of second parameters for the model can be generated from the set of first (historic) parameters 175 for the first live event and prior to updating the model. The model executor 140 can analyze data specific to the first live event including data on the teams or players involved, the event's location, historical performances in similar conditions, and other relevant variables that might impact the event's outcome. The set of second parameters undergoes a process of optimization by undergoing simulations or applying statistical methods (e.g., Monte-Carlo simulations) to update the first set of parameters 175. The parameter updater 145 can store the set of second parameters 175 in the storage 115 in association with an identifier of the first live event.

In some implementations, the request receiver 130 can receive a second request to generate odds for the first live event. The request receiver 130 can retrieve the set of second parameters 175 from the storage 115. The model executor 140 can execute the model using the set of second parameters to generate second odds for the first live event. The second odds can be expected to be more refined and accurate, having been derived from a parameter set that has undergone targeted optimization with respect to the first live event. The model executor 140 can generate the first odds based on an aggregation of the plurality of sets of first parameters 175. The model executor 140 can take the input data, including the first set of parameters 175, and runs the model 177 to produce odds for the event. The model executor 140 can process the data in real-time or near-real-time. The model executor 140 can generate the first odds for the first live event and initiate updating the model 177 in parallel. The updating the model 177 can be done by the parameter updater 145. The data processing system 105 can provide an indication to a second computing system that the model has been updated based on the set of target values.

The request received by the request receiver 130 or model maintainer 130 can specify that the parameters 175 do not require updating. For example, the user (requestor) can be confident that the parameters 175 are already optimized for the current conditions of the live event, or if the event in is similar to recent events that the model has successfully analyzed. The data processing system 105, via the request receiver 130, may analyze the incoming request and determine that an update to the parameters is unnecessary. The determination can be based on a comparison of the request details with the current parameters 175, where the data processing system 105 can assess whether the existing parameters 175 sufficiently match the requirements of the new request. The data processing system 105 can generate odds or predictions using the existing set of parameters 175 without initiating the update process. This approach can ensure efficiency by avoiding unnecessary recalibrations of the model 177, particularly when dealing with a high volume of requests or when operating under time constraints.

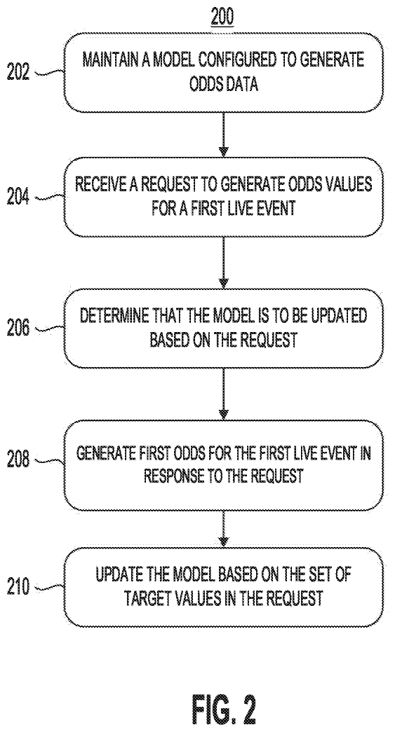

Referring to FIG. 2, illustrated is an example flow diagram of a method 200 for dynamically updating graphical user interfaces using probabilities from simulations, in accordance with one or more implementations. In brief overview of the method 200, the data processing system (e.g., the data processing system 105, etc.) can maintain a model configured to generate odds data for one or more live events (STEP 302), receive a request to generate odds values for a first live event (STEP 204), determine that the model is to be updated based on the request (STEP 206), generate first odds for the first live event in response to the request (STEP 208), and update the model based on the set of target values in the request (STEP 210). The model in the method can include a Monte-Carlo model.

In further detail of method 200, at STEP 202, the data processing system can select the type of model and define the input data requirements. A model can be selected for its ability to model complex systems and processes by using randomness and statistical distribution to predict outcomes. The data processing system can select the type of model based on the nature of the live events.

At STEP 204, the data processing system can receive a request to generate odds values for a first live event. The request can include a set of target values for the first live event. The data processing system can receive a second request to generate odds for the first live event. The request can include an indication that the model is to be updated.

At STEP 206, the data processing system can determine that the model is to be updated based on the request. The data processing system can analyze the odds request for certain triggers or flags that indicate the model update is necessary. The triggers or flags can be explicit instructions from the client device or inferred from the data provided. The data processing system can receive a second request to generate odds for the first live event. The data processing system can retrieve the set of second parameters from the database.

At STEP 208, the data processing system can generate first odds for the first live event in response to the request. The data processing system can generate the first odds for the first live event and initiate updating the model in parallel. The data processing system can generate the first odds based on an aggregation of the sets of first parameters. The data processing system can execute the model using the set of second parameters to generate second odds for the first live event.

At STEP 210, the data processing system can update the model by iteratively generating candidate input parameters based on the set of target values. The data processing system can adjust the parameters that the model uses to generate odds for the live events. The data processing system can compare the received target values against the outputs of the model. The data processing system can use the target values to adjust the model parameters until the model's generated odds align with the target odds included in the request. The data processing system can update the model by iteratively generating candidate second parameters based on the set of target values. The data processing system can store sets of first parameters including the set of first parameters for the first live event. The data processing system can generate a set of second parameters for the model that corresponding to the first live event. The data processing system can store the set of second parameters in a database in association with an identifier of the first live event. The data processing system can provide an indication to a second computing system that the model has been updated based on the set of target values.

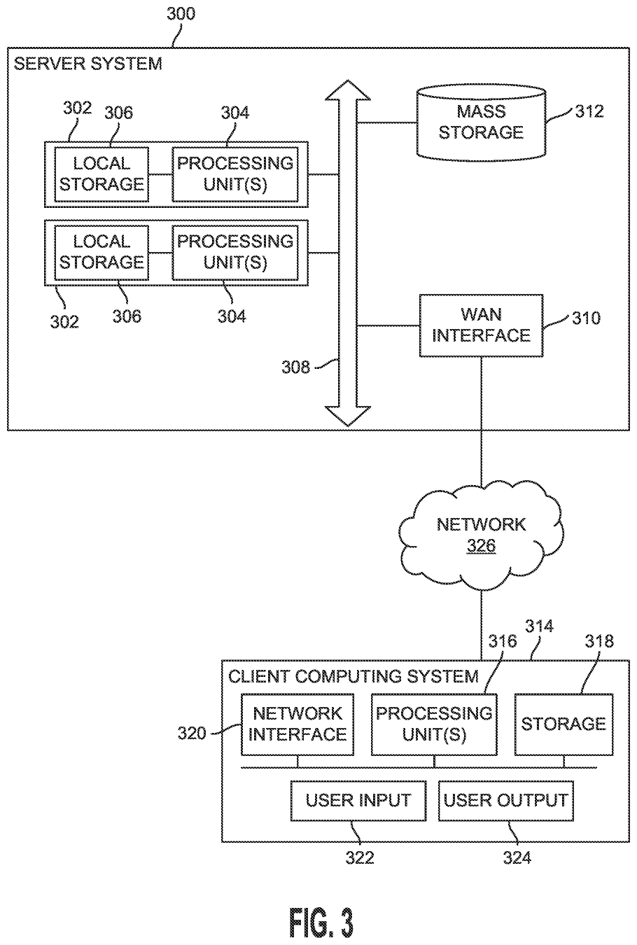

Various operations described herein can be implemented on computer systems. FIG. 3 shows a simplified block diagram of a representative server system 300, client computer system 314, and network 326 usable to implement certain implementations of the present disclosure. In various implementations, server system 300 or similar systems can implement services or servers described herein or portions thereof. Client computer system 314 or similar systems can implement clients described herein. The system (e.g., the data processing system 105A) and others described herein can be similar to the server system 300.

Server system 300 can have a modular design that incorporates a number of modules 302; while two modules 302 are shown, any number can be provided. Each module 302 can include processing unit(s) 304 and local storage 306.

Processing unit(s) 304 can include a single processor, which can have one or more cores, or multiple processors. In some implementations, processing unit(s) 304 can include a general-purpose primary processor as well as one or more special-purpose co-processors such as graphics processors, digital signal processors, or the like. In some implementations, some or all processing units 304 can be implemented using customized circuits, such as application specific integrated circuits (ASICs) or field programmable gate arrays (FPGAs). In some implementations, such integrated circuits execute instructions that are stored on the circuit itself. In other implementations, processing unit(s) 304 can execute instructions stored in local storage 306. Any type of processors in any combination can be included in processing unit(s) 304.

Local storage 306 can include volatile storage media (e.g., DRAM, SRAM, SDRAM, or the like) and/or non-volatile storage media (e.g., magnetic or optical disk, flash memory, or the like). Storage media incorporated in local storage 306 can be fixed, removable or upgradeable as desired. Local storage 306 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 304 need at runtime. The ROM can store static data and instructions that are needed by processing unit(s) 304. The permanent storage device can be a non-volatile read-and-write memory device that can store instructions and data even when module 302 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some implementations, local storage 306 can store one or more software programs to be executed by processing unit(s) 304, such as an operating system and/or programs implementing various server functions such as functions of the data processing systems 105.

“Software” refers generally to sequences of instructions that, when executed by processing unit(s) 304 cause server system 300 (or portions thereof) to perform various operations, thus defining one or more specific machine implementations that execute and perform the operations of the software programs. The instructions can be stored as firmware residing in read-only memory and/or program code stored in non-volatile storage media that can be read into volatile working memory for execution by processing unit(s) 304. Software can be implemented as a single program or a collection of separate programs or program modules that interact as desired. From local storage 306 (or non-local storage described below), processing unit(s) 304 can retrieve program instructions to execute and data to process in order to execute various operations described above.

In some server systems 300, multiple modules 302 can be interconnected via a bus or other interconnect 308, forming a local area network that supports communication between modules 302 and other components of server system 300. Interconnect 308 can be implemented using various technologies including server racks, hubs, routers, etc.

A wide area network (WAN) interface 310 can provide data communication capability between the local area network (interconnect 308) and the network 326, such as the Internet. Technologies can be used, including wired (e.g., Ethernet, IEEE 802.3 standards) and/or wireless technologies (e.g., Wi-Fi, IEEE 802.11 standards).

In some implementations, local storage 306 is intended to provide working memory for processing unit(s) 304, providing fast access to programs and/or data to be processed while reducing traffic on interconnect 308. Storage for larger quantities of data can be provided on the local area network by one or more mass storage subsystems 312 that can be connected to interconnect 308. Mass storage subsystem 312 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 312. In some implementations, additional data storage resources may be accessible via WAN interface 310 (potentially with increased latency).

Server system 300 can operate in response to requests received via WAN interface 310. For example, one of modules 302 can implement a supervisory function and assign discrete tasks to other modules 302 in response to received requests. Work allocation techniques can be used. As requests are processed, results can be returned to the requester via WAN interface 310. Such operation can generally be automated. Further, in some implementations, WAN interface 310 can connect multiple server systems 300 to each other, providing scalable systems capable of managing high volumes of activity. Techniques for managing server systems and server farms (collections of server systems that cooperate) can be used, including dynamic resource allocation and reallocation.

Server system 300 can interact with various user-owned or user-operated devices via a wide-area network such as the Internet. An example of a user-operated device is shown in FIG. 4 as client computing system 314. Client computing system 314 can be implemented, for example, as a consumer device such as a smartphone, other mobile phone, tablet computer, wearable computing device (e.g., smart watch, eyeglasses), desktop computer, laptop computer, and so on.

For example, client computing system 314 can communicate via WAN interface 310. Client computing system 314 can include computer components such as processing unit(s) 316, storage device 318, network interface 320, user input device 322, and user output device 324. Client computing system 314 can be a computing device implemented in a variety of form factors, such as a desktop computer, laptop computer, tablet computer, smartphone, other mobile computing device, wearable computing device, or the like.

Processor 316 and storage device 318 can be similar to processing unit(s) 304 and local storage 306 described above. Suitable devices can be selected based on the demands to be placed on client computing system 314; for example, client computing system 314 can be implemented as a “thin” client with limited processing capability or as a high-powered computing device. Client computing system 314 can be provisioned with program code executable by processing unit(s) 316 to enable various interactions with server system 300 of a message management service such as accessing messages, performing actions on messages, and other interactions described above. Some client computing systems 314 can also interact with a messaging service independently of the message management service.

Network interface 320 can provide a connection to the network 326, such as a wide area network (e.g., the Internet) to which WAN interface 310 of server system 300 is also connected. In various implementations, network interface 320 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 322 can include any device (or devices) via which a user can provide signals to client computing system 314; client computing system 314 can interpret the signals as indicative of particular user requests or information. In various implementations, user input device 322 can include any or all of a keyboard, touch pad, touch screen, mouse or other pointing device, scroll wheel, click wheel, dial, button, switch, keypad, microphone, and so on.

User output device 324 can include any device via which client computing system 314 can provide information to a user. For example, user output device 324 can include a display to display images generated by or delivered to client computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some implementations can include a device such as a touchscreen that function as both input and output device. In some implementations, other user output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 304 and 316 can provide various functionality for server system 300 and client computing system 314, including any of the functionality described herein as being performed by a server or client, or other functionality associated with message management services.

It will be appreciated that server system 300 and client computing system 314 are illustrative and that variations and modifications are possible. Computer systems used in connection with implementations of the present disclosure can have other capabilities not specifically described here. Further, while server system 300 and client computing system 314 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of these. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus”, “data processing system”, “client device”, “computing platform”, “computing device”, or “device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of these. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor can receive instructions and data from a read-only memory or a random access memory or both. The elements of a computer include a processor for performing actions in accordance with instructions and one or more memory devices for storing instructions and data. Generally, a computer can also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a player, implementations of the subject matter described in this specification can be implemented on a computer having a display device, e.g., a CRT (cathode ray tube), plasma, or LCD (liquid crystal display) monitor, for displaying information to the player and a keyboard and a pointing device, e.g., a mouse or a trackball, by which the player can provide input to the computer. Other kinds of devices can be used to provide for interaction with a player as well; for example, feedback provided to the player can include any form of sensory feedback, e.g., visual feedback, auditory feedback, or tactile feedback; and input from the player can be received in any form, including acoustic, speech, or tactile input. In addition, a computer can interact with a player by sending documents to and receiving documents from a device that is used by the player; for example, by sending web pages to a web browser on a player's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a player can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the gaming system described herein can include clients and servers. For example, the gaming system can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving input from a player interacting with the client device). Data generated at the client device (e.g., a result of an interaction, computation, or any other event or computation) can be received from the client device at the server, and vice-versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the gaming system could be a single module, a logic device having one or more processing modules, one or more servers, or part of a search engine.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, elements, or acts of the systems and methods herein referred to in the singular may also embrace implementations including a plurality of these elements; and any references in plural to any implementation, element, or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence has any limiting effect on the scope of any claim elements.

The systems and methods described herein may be embodied in other specific forms without departing from their characteristics thereof. The systems and methods described herein may be applied to other environments. The foregoing implementations are illustrative, rather than limiting, of the described systems and methods. The scope of the systems and methods described herein may thus be indicated by the appended claims, rather than the foregoing description, and changes that come within the meaning and range of equivalency of the claims are embraced therein.

1. A system, comprising:
one or more processors coupled to non-transitory memory, the one or more processors configured to:
maintain a model configured to generate odds data for one or more live events;
receive a first request to generate odds values for a first live event, the first request comprising a set of target values for the first live event;
determine that the model is to be updated based on the set of target values being included in the first request;
generate, using the model and a set of first parameters for the first live event, and prior to updating the model, first odds for the first live event in response to the first request;
following the determination that the model is to be updated, iteratively generate a set of second parameters for the model and the first live event based on the set of target values, the set of second parameters causing the model to generate the set of target values;
receive a second request to generate odds values for the first live event; and
generate, using the set of second parameters for the model and the first live event, second odds for the first live event in response to the second request.

2. The system of claim 1, wherein the model comprises a Monte-Carlo model.

3. The system of claim 1, wherein the first request comprises a flag indicating that the model is to be updated.

4. (canceled)

5. The system of claim 1, wherein the one or more processors are further configured to store the set of second parameters in a database in association with an identifier of the first live event.

6. The system of claim 5, wherein the one or more processors are further configured to:
retrieve the set of second parameters from the database; and
execute the model using the set of second parameters to generate the second odds for the first live event.

7. The system of claim 1, wherein the one or more processors are further configured to update the model by iteratively generating candidate second parameters based on the set of target values.

8. The system of claim 1, wherein the one or more processors are further configured to:
store a plurality of sets of first parameters for the model in a database, the plurality of sets of first parameters including the set of first parameters for the first live event; and
generate the first odds further based on an aggregation of the plurality of sets of first parameters.

9. The system of claim 1, wherein the one or more processors are further configured to generate the first odds for the first live event and initiate updating the model in parallel.

10. The system of claim 1, wherein the one or more processors are further configured to provide an indication to a second computing system that the model has been updated based on the set of target values.

11. A method, comprising:
maintaining, by one or more processors coupled to non-transitory memory, a model configured to generate odds data for one or more live events;
receiving, by the one or more processors, a first request to generate odds values for a first live event, the first request comprising a set of target values for the first live event;
determining, by the one or more processors, that the model is to be updated based on the set of target values being include in the first request;
generating, by the one or more processors, using the model and a set of first parameters for the first live event, and prior to updating the model, first odds for the first live event in response to the first request; and
following the determination that the model is to be updated, iteratively generating, by the one or more processors, a set of second parameters for the model and the first live event based on the set of target values, the set of second parameters causing the model to generate the set of target values;
receiving, by the one or more processors, a second request to generate odds values for the first live event; and
generating, by the one or more processors, using the set of second parameters for the model and the first live event, second odds for the first live event in response to the second request.

12. The method of claim 11, wherein the model comprises a Monte-Carlo model.

13. The method of claim 11, wherein the first request comprises a flag indicating that the model is to be updated.

14. (canceled)

15. The method of claim 11, further comprising storing, by the one or more processors, the set of second parameters in a database in association with an identifier of the first live event.

16. The method of claim 15, further comprising:
retrieving, by the one or more processors, the set of second parameters from the database; and
executing, by the one or more processors, the model using the set of second parameters to generate the second odds for the first live event.

17. The method of claim 11, further comprising updating, by the one or more processors, the model by iteratively generating candidate second parameters based on the set of target values.

18. The method of claim 11, further comprising:
storing, by the one or more processors, a plurality of sets of first parameters for the model in a database, the plurality of sets of first parameters including the set of first parameters for the first live event; and
generating, by the one or more processors, the first odds further based on an aggregation of the plurality of sets of first parameters.

19. The method of claim 11, further comprising generating, by the one or more processors, the first odds for the first live event and initiate updating the model in parallel.

20. The method of claim 11, further comprising providing, by the one or more processors, an indication to a second computing system that the model has been updated based on the set of target values.
